(19) United States
(12) Patent Application Publication
(10) Pub. No.: US 2016/0198131 A1
(43) Pub. Date: Jul. 7, 2016

(54) RGB/RWB SENSOR WITH INDEPENDENT INTEGRATION TIME CONTROL FOR IMPROVEMENT OF SNR AND COLOR ACCURACY

(71) Applicant: Samsung Electronics Co., Ltd., Suwon-si (KR)

(72) Inventors: Yibing M. WANG, Pasadena, CA (US); Lilong SHI, Pasadena, CA (US)

(21) Appl. No.: 14/712,891

(22) Filed: May 14, 2015

Related U.S. Application Data
(60) Provisional application No. 62/100,468, filed on Jan. 6, 2015.

(51) Int. Cl. H04N 9/04; G06T 7/00; G06T 3/40

(52) U.S. Cl. CPC H04N 9/045; G06T 3/4015; G06T 7/0004; G06T 7/0012; H04N 2209/045; G06T 2207/10024; G06T 2207/20024

(57) ABSTRACT

An image sensor includes a first array of pixels exhibiting a first sensitivity; a second array of pixels exhibiting a second sensitivity; wherein, the first array of pixels is electrically separated from the second array of pixels. Methods of use and devices using the image sensor are disclosed.

### BACKGROUND

1. Field

The present disclosure herein relates to imaging sensors, and in particular to improved design that provides improved spectral response.

2. Description of the Related Art

In today's world, there is an increasing need for effective imaging devices. For example, urban areas are under constant surveillance to monitor security risk. The never-ending competition with mobile computing makes constant additions to imaging capabilities. While many improvements have been made through increases in processing power, improvements in optics, and providing larger arrays, there is still opportunity for improvement.

### SUMMARY

In one embodiment, an image sensor is provided. The image sensor includes a first array of pixels exhibiting a first sensitivity; a second array of pixels exhibiting a second sensitivity; wherein, the first array of pixels is electrically separated from the second array of pixels.

The first array of pixels may correlate to at least one of white filters and green filters in a color filter mosaic included in the image sensor. The first array of pixels may correlate to at least one of red filters and blue filters in a color filter mosaic included in the image sensor. Integration time for the first array and integration time for the second array may be separated from each other. Electrical interconnection between pixels in the first array and electrical interconnection between pixels in the second array may include a zig-zag pattern. Electrical interconnection between pixels in the first array and electrical interconnection between pixels in the second array may be oriented relative to a color filter mosaic included in the image sensor. The first array and the second array may be reset by turning on RST and TX transistors.

In another embodiment, a method for avoiding saturation of pixels in an imaging sensor is provided. The method includes selecting an image sensor including a first array of pixels exhibiting a first sensitivity; a second array of pixels exhibiting a second sensitivity; wherein, the first array of pixels is electrically separated from the second array of pixels; and, setting a first integration time for the first array according to the first sensitivity, and setting a second integration time for the second array according to the second sensitivity, wherein the first integration time and the second integration time are determined according to the saturation.

Setting the first integration time may include calculating a weighted average of response by pixels within the first array and setting the second integration time may include calculating a weighted average of response by pixels within the second array. This may further include capturing a frame using the first integration time and the second integration time as well as calculating an integration time ratio between the first array and the second array as well as storing at least one of the first integration time, the second integration time and the integration time ratio in memory.

The method may further include associating the first array with one of a set of green color filters and/or white color filters. The method may further include associating the second array with a set of red color filters and blue color filters.

In yet another embodiment, an imaging device is disclosed. The device includes a dual array image sensor; and, a processor for controlling the dual array image sensor and providing images from the dual array image sensor.

The device may include one of a camera configured for photography, a mobile device including a camera, a diagnostic imaging device, and an industrial imaging device. The device may further include a set of machine executable instructions stored on machine readable media, the set of machine executable instructions configured for controlling the dual array image sensor. The device may further include a communication interface configured for communicating images from the device.

### BRIEF DESCRIPTION OF THE DRAWINGS

The features and advantages of the present disclosure are apparent from the following description taken in conjunction with the accompanying drawings in which:

FIGS. 1A and 1B, collectively referred to herein as FIG. 1, are schematic diagrams depicting color mosaic filters, where FIG. 1A depicts an RGB mosaic pattern and FIG. 1B depicts a RWB mosaic pattern; and

FIG. 2 is a cutaway schematic of a mosaic filter disposed over a pixel array;

FIG. 3 depicts a prior art high-level topology for a pixel array in relation to an RGB mosaic filter;

FIG. 4 depicts a high-level topology for a pixel array in relation to an RWB mosaic filter;

FIG. 5 depicts another embodiment of a high-level topology for a pixel array in relation to an RWB mosaic filter;

FIG. 6 depicts the electrical topology of FIG. 4 in greater detail;

FIG. 7 is a timing chart depicting relationship temporal aspects of readout of the sensor depicted in FIG. 6;

FIG. 8 is a flow chart depicting a process for adjusting white balance;

FIG. 9 depicts aspects of a camera for use of the sensor disclosed herein;

FIGS. 10A and 10B, collectively referred to herein as FIG. 10, depict aspects of a mobile device for use of the sensor disclosed herein; and,

FIG. 11 depicts aspects of a processing system for the sensor disclosed herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

### DETAILED DESCRIPTION

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments will be explained in detail with reference to the accompanying drawings.

As used herein, the term “and/or” includes any and all combinations of one or more of the associated listed items. Expressions such as “at least one of,” when preceding a list of elements, modify the entire list of elements and do not modify the individual elements of the list. As used herein, the term “exemplary” refers to one of many possible embodiments, and is not intended to indicate a superlative.

The embodiments of the inventive concept are provided to more fully describe the inventive concept to those of ordinary skill in the art, and the following embodiments may be modified in various different forms and the scope of the inventive concept is not limited to the following embodiments. Rather, those embodiments are provided so that this disclosure will be thorough and complete, and will fully convey the scope of the inventive concept to those of ordinary skill in the art.

Herein, it would be obvious that although terms such as “first,” “second,” or the like may be used to describe various members, regions, layers and/or elements, these members, regions, layers and/or elements should not be limited by these terms. These terms do not mean a particular order, top and bottom, or superiority or inferiority, and are only used to distinguish one member, region, layer and/or element from another member, region, layer and/or element. Thus, a first member, region, layer and/or element discussed below could be termed a second member, region, layer and/or element, and similarly, a second member, region, layer and/or element may be termed a first member, region, layer and/or element without departing from the teachings of the inventive concept.

Unless defined otherwise, all terms (including technical and scientific terms) used herein may be used as meanings which can be in common understood by those having ordinary skill in the art. Further, terms defined in general dictionaries should not be interpreted ideally or excessively, unless defined otherwise.

When a certain embodiment may be implemented differently, a particular processing order may be different from that described below. For example, two processes described successively may be performed substantially at the same time or may be performed in a reverse order to that described below.

Disclosed herein are methods and apparatus for providing an imaging sensor that includes two independent sets of pixels. The independent sets of pixels may separate integration intervals. By grouping high sensitivity pixels into one of the sets, and lower sensitivity pixels into the other set, sensitivity of the imaging sensor may be closely controlled. As a result, greater color accuracy is achieved. It should be recognized that the embodiments disclosed herein are merely illustrative and are not limiting of the technology.

As discussed herein, groupings of independent sets of pixels may include pixels with performance characteristics that are reasonably similar, while not necessarily equivalent. That is, a first array of pixels may exhibit a first sensitivity that extends over reasonably broad range, while a second array of pixels may exhibit a second sensitivity that extends over a different and also reasonably broad range. It is not required that differing types of pixels within the first or second array of pixels all exhibit the same sensitivity. For example, green (G) pixels and white (W) pixels may be included in the first array, while blue (B) pixels and red (R) pixels may be included in the second array. It is not expected or required that the sensitivity of the green pixels matches the sensitivity of the white pixels, but that the sensitivity of the green pixels and the white pixels may be similar or substantially similar when compared with either one of the blue pixels and the red pixels. Conversely, it is not expected or required that the sensitivity of the blue pixels from matches the sensitivity of the red pixels, but that the sensitivity of the blue pixels and the red pixels may be similar or substantially similar when compared to either one of the green pixels or the white pixels.

Accordingly, a first sensitivity may include groups of pixels exhibit performance characteristics that are somewhat diverse, but distinct from groups of pixels associated with a second sensitivity. In short, the particular pixels that are grouped into the first array of pixels are functionally equivalent, while the particular pixels that are grouped into the second array of pixels are also functionally equivalent and exhibit performance that differs from the first array of pixels. Measures of performance are to be determined by a user, designer, manufacturer or other similarly interested party.

In order to provide some context for the teachings herein, some terminology and aspects of imaging sensors are now introduced.

As discussed above, improvements in optics, and providing larger arrays, there is still opportunity for improvement. Consider, for example, the construction of imaging sensors configured to sense color images.

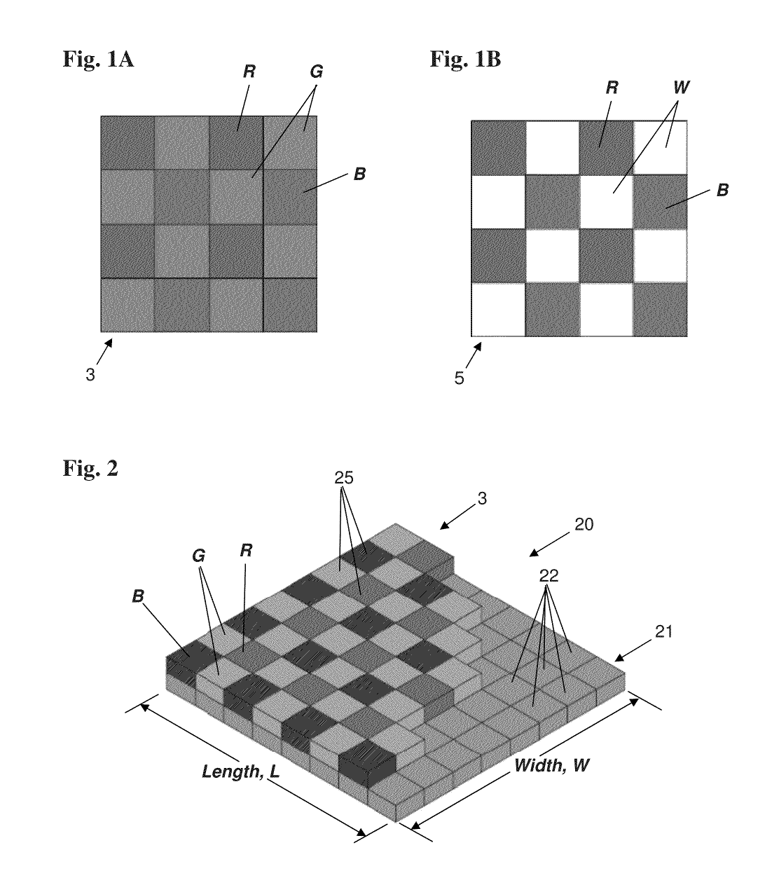

One example of an imaging sensor that is not without complications includes a biased color filter array. More specifically, and as an example, a Bayer filter mosaic includes a pattern where the pixels are 50% green, 25% red and 25% blue. Ostensibly, this mimics the physiology of the human eye and therefore should produce results that are more color accurate. Another combination that is used involves a cyan, magenta, and yellow combination. A further combination includes white, red and blue filters. These mosaic patterns or filters are referred to as “RGGB,” “RGBW,” “CMY,” “RYB,” “RWB.” In these exemplary patterns, R represents red, G represents green, B represents blue, W represents white, C represents cyan, M represents magenta, and Y represents yellow. Of course, there are additional variations of these basic arrangements. FIG. 1A and FIG. 1B depicts examples of mosaic patterns used with imaging sensors, where FIG. 1A depicts a RGB color filter 3 arranged in a Bayer pattern, and FIG. 1B depicts a RWB color filter 5, also arranged in a Bayer pattern.

In FIG. 1, each separate block is disposed over a pixel that is part of an array of pixels (also referred to as a “pixel array”). In these illustrations, each array is 4×4 pixels. Unfortunately, existing sensor arrays do not respond well to these patterns. More specifically, pixels associated with green filters and pixels associated with white filters (simply referred to as “green pixels” and “white pixels,” respectively) are more sensitive to light then the remaining pixels within the respective pixel array.

As a result, images collected with prior art imaging sensors most often have somewhat inaccurate color balance. That is, as green pixels and white pixels become saturated more quickly than the remaining pixels in the respective pixel arrays, color accuracy is reduced. Loss of color accuracy may be offset somewhat by reducing an integration time for a given array. This is not without consequence. With lower integration time, there are attendant reductions in signal. When operating in lowlight conditions, this may result in poor red and/or blue signal data.

Thus, what are needed are methods and apparatus to enhance accuracy of imaging with a pixel array used in an imaging sensor. Preferably, the methods and apparatus account for variation in sensitivity of the various color pixels used in conventional mosaic patterns

Refer to FIG. 2 where a cutaway isometric view of an imaging sensor 20 is shown. Generally, the imaging sensor 20 includes a plurality of pixels 22 disposed in a pixel array 21. In this example, the pixel array 21 is two-dimensional and is characterized by having a length, L, and a width, W. Disposed on top of the pixel array 21 is an RGB color filter 3. The RGB color filter 3 includes an array of green filters, G; red filters, R; and blue filters, B. Generally, each filter element 25 in the RGB color filter 3 correlates to a pixel 22 within the pixel array 21. In practice, the imaging sensor 20 may have hundreds to thousands of pixels 22 extending along the length, L, and/or the width, W.

Of course, other filter arrangements may include other colors as well as other relationships. For purposes of introduction alone, technology disclosed herein is with regards to the RGB color filter 3 and/or the RWB color filter 5. Additionally, it should be noted that the RGB color filter 3 may be more accurately described (and also referred to) as including a RGBG pattern. Similarly, the RWB color filter 5 may be more accurately described (and also referred to) as including a RWBW pattern. Accordingly, these arrangements are merely illustrative and are not to be construed as limiting.

When in use, incident light travels through the RGB color filter 3. Interaction of photons within each of the pixels 22 causes a collection of charge. Periodic reading of the charge accumulated in each pixel 22 (also referred to as “draining” a pixel), it is possible to determine the quantity of the incident light for each pixel 22. Generally, draining of pixels occurs on a row-by-row basis, where charge from the first pixel 22 in a selected row is drained, followed by the second pixel, the third pixel and so on. Once charge has been collected from all the pixels 22 in the pixel array 21, it is possible to construct an image. That is, by use of external processing capabilities, it is possible to assemble an image that correlates to the image viewed by the imaging sensor 20.

As discussed above, some of the problems with an imaging sensor 20 constructed according to conventional techniques includes the disparity in charge collection between pixels 22 that are associated with green or white filter elements 25 and red or blue filter elements 25. Rapid cycling of the readout of the imaging sensor 20 may cause red or blue pixels 22 to be drained prior to collection of an adequate signal (that is, there is an inadequate signal to noise ratio (SNR)). In contrast, inadequate cycling of the readout of the imaging sensor 20 may cause saturation of green or white pixels 22, and therefore signal loss (that is, there is signal clipping). Given that the imaging sensor 20 is used in lighting conditions that vary substantially, it is nearly impossible to adjust the readout interval of the imaging sensor 20 for a perfect balance of signal-to-noise ratio (SNR) and signal clipping.

Note that use of terminology regarding orientation including “top” as well as the term “bottom” is arbitrary and is with reference to the figures merely for purposes of explanation. This is not to imply any limitations regarding orientation of the imaging sensor 20 or components related thereto.

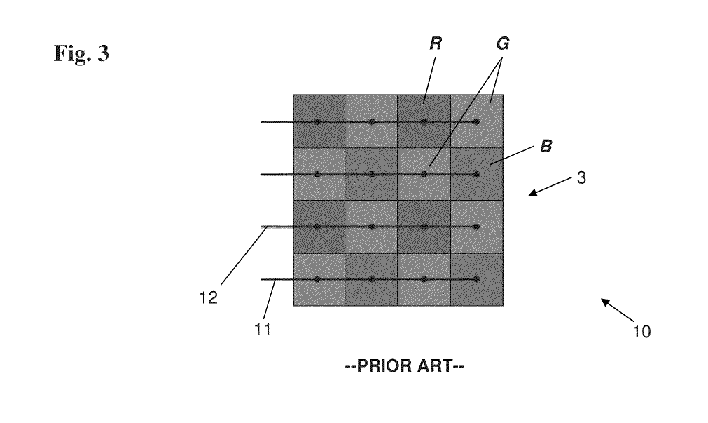

Referring now to FIG. 3, where a prior art sensor 10 is shown. In this illustration, electrical topology for the pixel array 21 is shown at a high level in association with the RGB color filter 3. For purposes of clarity, the pixel array 21 is not shown. The electrical connections to the pixel array 21 are shown in relation to the RGB color filter 3. The electrical topology includes a plurality of rows. In this example, the first row 11 includes a metallized trace that connects a series of green and blue pixels 22. The second row 12 includes a metallized trace that connects a series of red and green pixels 22. In simple terms, the metallized trace in each row connects each of the pixels 22 in that row. Accordingly, highly sensitive pixels 22 such as pixels 22 that are colored green and which require shorter intervals for charge collection (which is referred to herein as “integration time”) are coupled in series with less sensitive pixels 22, such as pixels 22 that are colored blue or red.

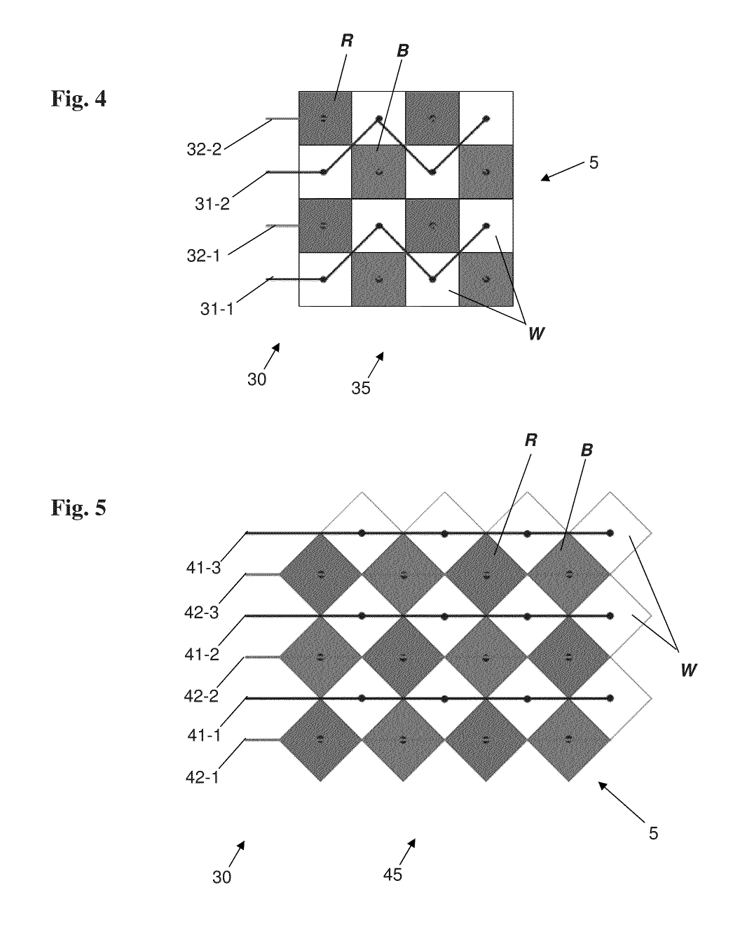

Referring now to FIG. 4, a first embodiment of a dual array image sensor 30 is shown. The dual array image sensor 30 may be deployed as a complimentary metal-oxide sensor (CMOS) device, a charge-coupled device (CCD) or other type of device. Similar to the illustration of FIG. 3, electrical topology for the pixel arrays is shown at a high level in association with the RWB color filter 5. The device is referred to as having a “dual array” as the device includes two independent sets of pixels 22. That is, in this exemplary embodiment, the first array 31 includes all of the white pixels 22. The second array 32 includes all of the blue pixels 22 and the red pixels 22.

The independent sets of pixels 22 may be managed separately. That is, by grouping high sensitivity pixels into one of the sets (in this case, the first array 31), and lower sensitivity pixels into the other set (in this case, the second array 32), sensitivity of the dual array image sensor 30 may be closely controlled. More specifically, parameters such as the integration time for the first array 31 may be set to values different than those chosen for the second array 32.

In the embodiment shown in FIG. 4, the first array 31 is shown as including a first row 31-1 and a second row 31-2. The second array 32 is shown as including a first row 32-1 and a second row 32-2. Of course, the dual array image sensor 30 may include as many more columns and rows. In this example, each row includes a conductor for conducting charge to and from the pixels 22. The conductor includes a layout of metallized trace. In this case, the metallized trace is referred to as functionally having a “zig-zag” pattern, and may therefore be referred to as a “zig-zag array image sensor 35.” Although the metallized trace (that is, the conductor) of the first array 31 intersects with the metallized trace (that is, the conductor) of the second array 32 in places, the first array 31 is insulated from the second array 32 at each of these intersections using techniques as are known in the art.

In FIG. 5, in another embodiment of the dual array image sensor 30 is shown. In this example, the dual array image sensor 30 includes a series of rows that are characterized by a linear metallized trace. In order to ensure alignment with the respective color filters, the color filter mosaic is rotated at some angle from the series of rows of conductors. Accordingly, this embodiment of the dual array image sensor 30 may be referred to as an “oriented image sensor 45.”

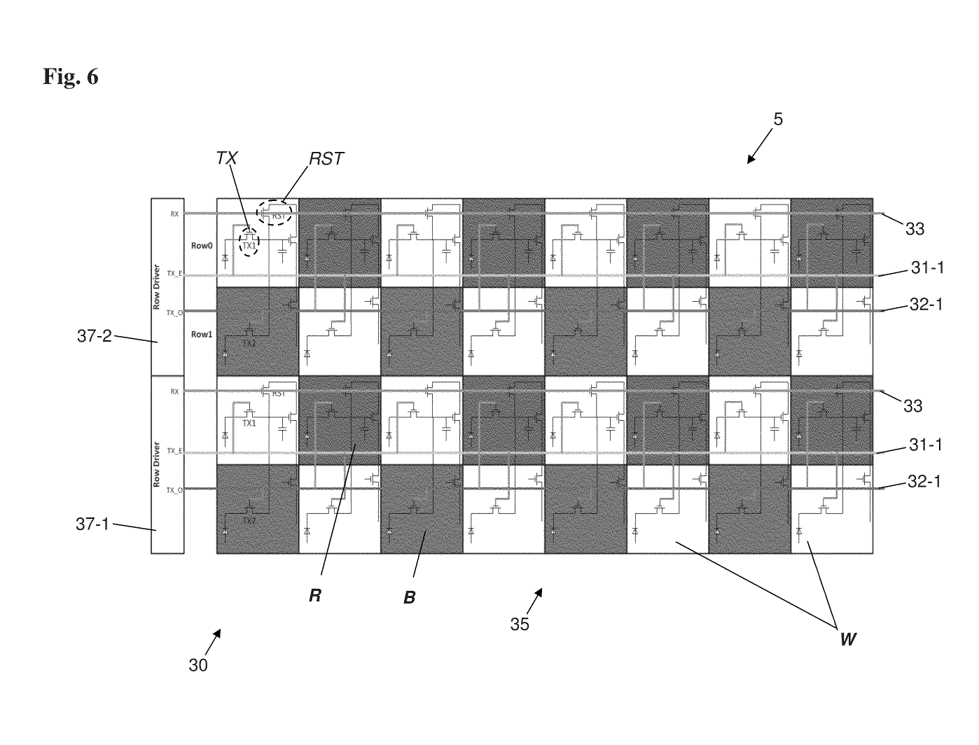

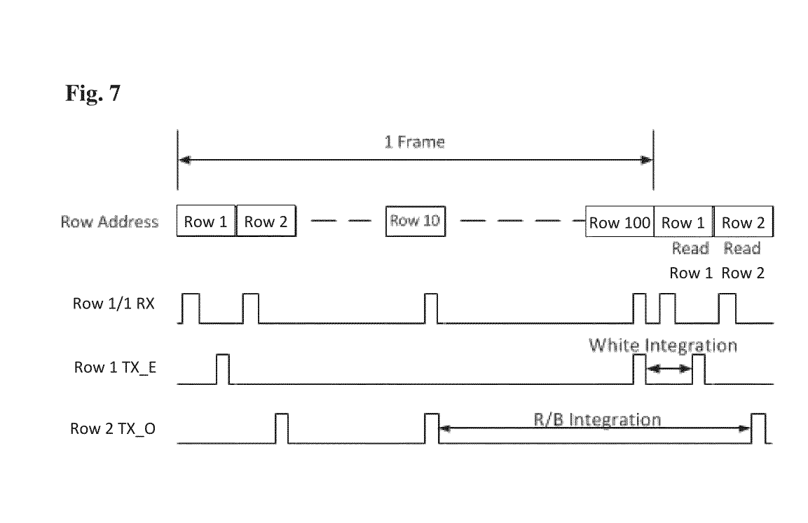

FIG. 6 provides an exemplary and more detailed embodiment of an electrical topology for the dual array image sensor 30 depicted in FIG. 4. In this example, two rows of pixels 22 are illustrated. Each row is controlled through a respective row driver 37-1, 37-2. The row drivers 37-1, 37-2 provide for resetting of the pixels 22 and collecting charge from the pixels 22. Each of the white pixels 22 are connected to the TX_E gate (transmit, even) shown in each row driver 37-1, 37-2. Each of the red pixels 22 and the blue pixels 22 are connected to the TX_O gate (transmit odd) shown in each row driver 37-1, 37-2. Reset of each pixel 22 is accomplished by simultaneously turning on a series of RST transistors with a series of TX transistors.

With the design illustrated in FIG. 6, two separate arrays of pixels 22 are maintained. The first array 31 and the second array 32 may be operated independently from each other. Independent operation provides for, among other things, using different integration times for each of array. Use of different integration times for the first array 31 and the second array 32 is illustrated in FIG. 7.

FIG. 7 is a chart that depicts aspects of timing for reading the dual array image sensor 30. In this exemplary embodiment, the dual array image sensor 30 includes 100 rows. Accordingly, readout of all 100 rows provides for one frame (that is, a complete image). The white pixels 22 of rows one (1) and two (2) are reset at row one-hundred (100) and are read at row one (1). That is, integration time is one (1) row. Red pixels 22 and blue pixels 22 of rows one (1) and two (2) are reset at row ten (10) and read at row one (1). Integration time is ninety one (91) rows. During operation, each pixel continuously integrates photoelectrons. When RX and TX are pulsed together, the accumulated charge is cleared from the pixel. The next time RX is pulsed, the charge inside the floating diffusion (FD) node (the gate of the output source follower) of the pixel is cleared. Then, when TX is pulsed, the newly accumulated charge is transferred to the FD node in the pixel for readout.

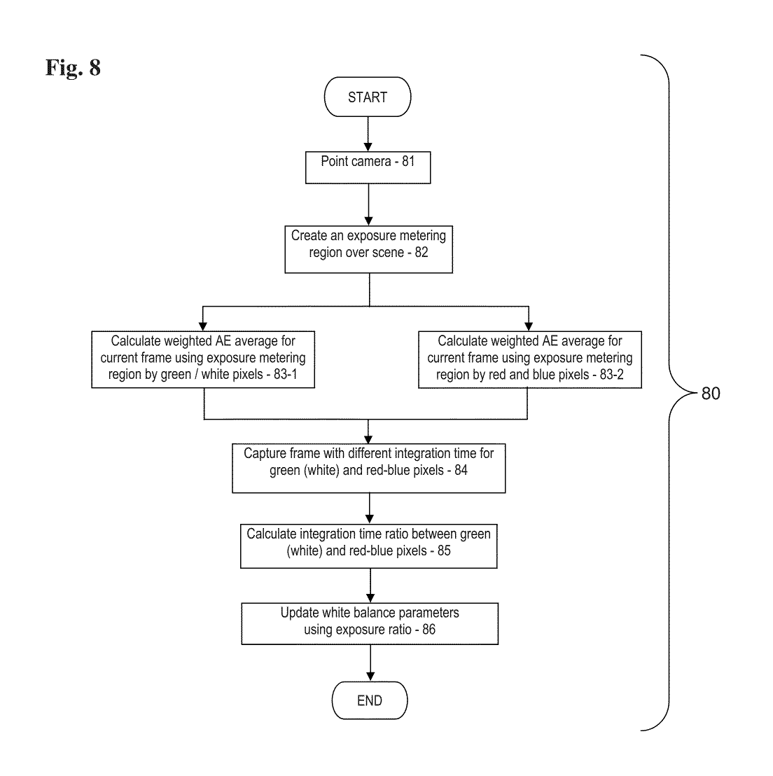

Advantageously, having a device that incorporates the dual array image sensor 30 permits a user to exert a finer control over imaging processes. For example, the user may adjust the device for an appropriate white balance used for image collection. This process is discussed with regards to FIG. 8.

FIG. 8 provides a flowchart with an exemplary process for adjusting white balance in a device such as a camera. The method for adjusting white balance 80 begins by pointing the camera 81. The user will then select an exposure metering region 82. Processing onboard the camera will then proceed with calculating a weighted average for arrays of pixels 83-1, 83-2. More specifically, the processor will receive data from the first array 31 and proceed with calculating exposure settings for the green and/or white pixels 22 contained in the first array 31. Similarly, the processor will receive data from the second array 32 and proceed with calculating exposure settings for the blue and red pixels 22 contained in the second array 32. The exposure settings for the first array 31 and exposure settings for the second array 32 are used to adjust integration times for each of the respective arrays. In the next step, the camera will proceed with collecting an image 84 (capture a frame) using the revised integration times. After collecting an image 84, the camera will proceed with calculating an integration time ratio 85 and provide an exposure ratio. After calculating the integration time ratio 85 (that is, the exposure ratio), the camera will proceed with updating white balance parameters with the exposure ratio 86.

After adjusting white balance 80 is completed, the user may then begin collecting images with the device. Images collected should have an appropriate balance of white or green with red and blue pixels.

A comparison of imaging data is provided in Table 1. More specifically, Table 1 compares imaging results from three (3) different imaging schemes for a trial exposure of different sensors.

TABLE 1
Imaging Results

| | Sensor type | | |
|---|---|---|---|
| | RWB, | RWB, | RWB, |
| Parameter | single array | single array | dual array |
| Integration time | 4.2 ms | 2.3 ms | 2.3 ms (W)/ |
| | | | 4.2 ms (RB) |
| White component | Overexposed | Good | Good |
| Red/blue component | Good | Underexposed | Good |
| Result | Wrong color and | High color | Good color and |
| | bright areas | noise | low color noise |

Advantageously, the dual array image sensor 30 does not perturb pixel matching (flat fielding) used to address photo response non-uniformity (PRNU).

A variety of devices may make use of the dual array image sensor 30. Exemplary devices include a camera intended for photography, a mobile device, equipment used for diagnostic imaging, industrial imaging devices, and other specialty devices.

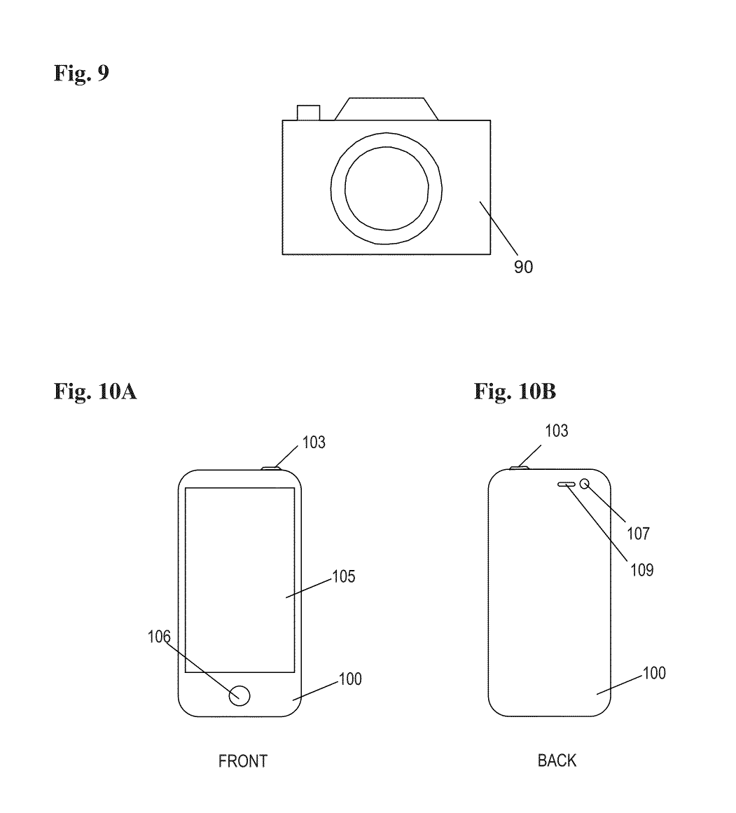

FIG. 9 depicts aspects of an exemplary camera 90 for making use of the dual array image sensor 30 disclosed herein. In this example, the camera 90 is substantially similar to a personal use or professional use digital single lens reflex (DSLR) camera.

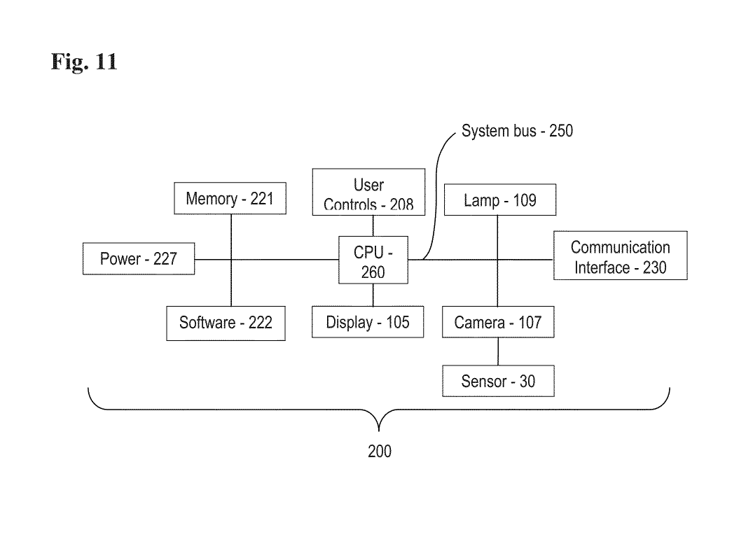

FIG. 10 depicts aspects of a mobile device 100 suited for making use of the dual array image sensor 30 disclosed herein. In this example, the mobile device 100 is a “smart phone.” Salient aspects of the mobile device 100 include a home button 106, an on/off switch 103, a display 105, a camera 107, and a lamp 109. Generally, the foregoing components are conventional and provide functionality that is well known in the art. The mobile device 100 may be referred to herein as “smart phone 100” and by other similar terms. Exemplary smart phones include the IPHONE from Apple Corp. of Cupertino, Calif., devices operating on the ANDROID platform of Google Corp. of Mountain View, Calif., as well as devices operating in the WINDOWS environment provided by Microsoft Corp. of Redmond, Wash.

For purposes of convention and to aid in the discussion herein, terms of orientation are provided. For example, FIG. 10A depicts the front of the mobile device 100. FIG. 10B depicts the back of the mobile device 100. The terms of orientation are with reference to orientation during operation of the mobile device 100.

Referring now to FIG. 11, an exemplary topology 200 the mobile device 100 is provided. The exemplary topology 200 depicts some of the components implemented in the mobile device 100. Included in the exemplary topology 200 is at least one central processing unit (CPU) 260. The central processing unit (CPU) 260 is connected to or in communication with other components through system bus 250. Exemplary other components include a power supply 227, memory 221, software 222, user controls 208 (such as the home button 106 and the on/off switch 103), the display 105, the camera 107, the lamp 109, and an interface 230.

The interface 230 may include a wired interface and/or a wireless interface. Exemplary wireless interfaces make use of protocol such as Bluetooth, Wi-Fi, near field technology (NFC) or other technology. The interface 230 may include an auditory channel. That is, the interface 230 may include a microphone for receiving voice commands, and may further include a speaker. In some embodiments, the speaker may provide an auditory signal when a barcode has been read. The interface 230 may further include a status light or other such visual indicators.

The mobile device 100 may include additional components such as an accelerometer that provides for orientation information, the GPS sensor that provides for location information, and other such devices.

As discussed herein, the term “software” 222 generally refers to machine readable instructions that provide for implementation of the method. The machine readable instructions may be stored on non-transitory machine readable media such as memory 221. Exemplary methods that may be implemented include instructions for operation of the camera 107, the lamp 109, communications through interface 230, and other aspects as discussed further here in. In some of the exemplary embodiments discussed herein, the software 222 provides for controlling the dual array image sensor 30, and may perform tasks such as adjusting white balance 80 or collecting images. It should be noted that the term “software” may describe sets of instructions to perform a great variety of functions.

The memory 221 may include multiple forms of memory. For example, the memory 221 may include non-volatile random access memory (NVRAM) and/or volatile random access memory (RAM). Generally, the non-volatile random access memory (NVRAM) is useful for storing software 222 as well as data generated by or needed for operation of the software 222. The memory 221 may include read only memory (ROM). The read only memory (ROM) may be used to store firmware that provides instruction sets necessary for basic operation of the components within the topology 200.

The interface 230 provides for, among other things, voice communications as well as data communications. The data communications may be used to provide for communication of software, data (such as at least one image; results of analyses, and other such types of data). Communication through the interface 230 may be bi-directional or in a single direction.

The camera 107 may include any appropriate sensor and optical elements needed to create images of items such as a barcode. The lamp 109 may include any appropriate source of illumination. Exemplary components for the lamp 109 include at least one light emitting diode (LED).

Although the exemplary mobile device 100 disclosed is a smart phone, the mobile device 100 is not limited to this embodiment and may include other devices. Accordingly, it is not required that the mobile device 100 incorporate all of the components of FIG. 11, and other components may be included.

While the technology disclosed herein has been discussed with regard to two-dimensional pixel arrays, this is not limiting. That is, the teachings herein may be applied to equally well, for example, one-dimensional pixel arrays as well as any other type of array where separation of pixels according to sensitivity or performance is desired.

The dual array image sensor 30 may be manufactured in variety of ways. In one embodiment, manufacture of the dual array image sensor 30 involves selecting a pixel array and interconnecting one subset of pixels within the pixel array and then interconnecting remaining pixels within the pixel array. This results in a pixel array that has a first subset of pixels (that is, the first array) and a second subset of pixels (that is, the second array). Subsequently, an appropriate color filter may be disposed over the pixel array (that includes the first array and the second array).

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not to be construed as a superlative, but merely as one example of many other possible examples.

While the present disclosure has been described with reference to exemplary embodiments, it will be understood by those skilled in the art that various changes may be made and equivalents may be substituted for elements thereof without departing from the scope of the present disclosure. In addition, many modifications will be appreciated by those skilled in the art to adapt a particular instrument, situation or material to the teachings of the present disclosure without departing from the essential scope thereof. Therefore, it is intended that the present disclosure not be limited to the particular embodiment disclosed as the best mode contemplated for carrying out this invention, but that the present disclosure will include all embodiments falling within the scope of the appended claims.

What is claimed is:

1. An image sensor comprising:
a first array of pixels exhibiting a first sensitivity;
a second array of pixels exhibiting a second sensitivity; wherein, the first array of pixels is electrically separated from the second array of pixels.

2. The image sensor as in claim 1, wherein the first array of pixels correlates to at least one of white filters and green filters in a color filter mosaic included in the image sensor.

3. The image sensor as in claim 1, wherein the first array of pixels correlates to at least one of red filters and blue filters in a color filter mosaic included in the image sensor.

4. The image sensor as in claim 1, wherein integration time for the first array and integration time for the second array are separable.

5. The image sensor as in claim 1, wherein electrical interconnection between pixels in the first array and electrical interconnection between pixels in the second array comprise a zig-zag pattern.

6. The image sensor as in claim 1, wherein electrical interconnection between pixels in the first array and electrical interconnection between pixels in the second array are oriented relative to a color filter mosaic included in the image sensor.

7. The image sensor as in claim 1, wherein the first array and the second array are reset by turning on RST and TX transistors.

8. A method for avoiding saturation of pixels in an imaging sensor, the method comprising:
selecting an image sensor comprising a first array of pixels exhibiting a first sensitivity; a second array of pixels exhibiting a second sensitivity; and,
setting a first integration time for the first array according to the first sensitivity, and setting a second integration time for the second array according to the second sensitivity, wherein the first integration time and the second integration time are determined according to the saturation.

9. The method as in claim 8, wherein setting the first integration time comprises calculating a weighted average of response by pixels within the first array and setting the second integration time comprises calculating a weighted average of response by pixels within the second array.

10. The method as in claim 9, further comprising capturing a frame using the first integration time and the second integration time.

11. The method as in claim 10, further comprising calculating an integration time ratio between the first array and the second array.

12. The method as in claim 11, further comprising storing at least one of the first integration time, the second integration time and the integration time ratio in memory.

13. The method as in claim 8, further comprising associating the first array with one of a set of green color filters and white color filters.

14. The method as in claim 8, further comprising associating the second array with a set of red color filters and blue color filters.

15. An imaging device comprising:
a dual array image sensor; and, a processor for controlling the dual array image sensor and providing images from the dual array image sensor.

16. The imaging device as in claim 15, wherein the device comprises one of a camera configured for photography, a mobile device comprising a camera, a diagnostic imaging device, and an industrial imaging device.

17. The imaging device as in claim 15, further comprising a set of machine executable instructions stored on machine readable media, the set of machine executable instructions configured for controlling the dual array image sensor.

18. The imaging device as in claim 15, further comprising a communication interface configured for communicating images from the device.
